(19) United States
(12) Patent Application Publication
(10) Pub. No.: US 2009/0219972 A1
(43) Pub. Date: Sep. 3, 2009

(54) DEVICE AND METHOD FOR MEASURING TEMPERATURE OVER AN AREA

(76) Inventors: Anders Carlsson, Linkoping (SE); Ulf Glendor, Linkoping (SE); Anita Jernberg, Norrkoping (SE); Billy Nilson, Mjolby (SE); Joakim Wren, Motala (SE)

Correspondence Address: HAYES SOLOWAY P.C., 3450 E. SUNRISE DRIVE, SUITE 140, TUCSON, AZ, 85718, US

(21) Appl. No.: 12/295,602

(22) PCT Filed: Mar. 30, 2007
(86) PCT No.: PCT/SE2007/000309

§ 371 Date: Jan. 30, 2009

(30) Foreign Application Priority Data
Mar. 30, 2006 (SE) 0600720-7

(51) Int. Cl. G01K 11/12; G01K 3/00

(52) U.S. Cl. 374/137; 374/162; 374/E03.001; 374/E11.018

(57) ABSTRACT

Device for registration of temperature over an area by means of thermochromatic materials, which includes one, two or several layers (1, 3) with thermochromatical material, and one or several surrounding heat storing plastic layers (4, 6) that extend the reading time with maintained heat picture. In the case with several thermochromatic layers these preferably are of different termocromatical materials reacting at different temperatures and so chosen and so arranged that the termocromatic materials together constitute a scale of temperature areas. By means of a template the colors in the termocromatic layers can be interpreted to temperatures or temperature intervals and be noted.

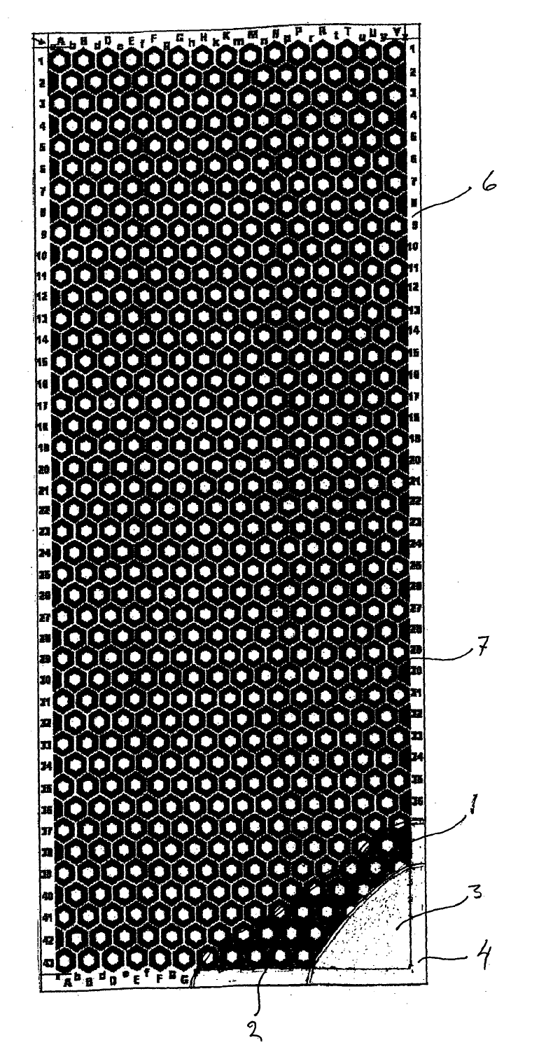

The present invention is related to a device for measuring temperature conditions over an area. In order to measure different temperatures over an area it is known to use thermochromatic materials or mixtures thereof embedded in, or as a coating on suitable carriers as for instance plastic film or paper sheets, accordingly constituting layers of thermochromatic material. The used thermochromatic material is by appropriate choice of materials and mixtures sensible to different temperatures and reacts by getting different colors depending on the temperature.

A problem at the use of thermochromatic devices is that the obtained color picture immediately disappear when a contact with the measured object ends. This problem is for instance present at a desired measuring of foot sole temperatures, were one would like to have thin measuring device that can register the temperature variations. Temperature variations in the soles of the feet may indicate circulation disturbances that in the long run may lead to amputations, something that is not unusual at for instance age diabetes. A solution were patient and care provider are so placed that reading may take place with a thermochromatic device in contact with the feet that are to be measured is of course possible to imagine but presumably neither practical nor comfortable. It becomes even more difficult if you want to check your own feet, which as realized is desirable.

In connection with the use of thermochromatic devices for the measuring of temperatures and the obtaining of temperature pictures there is thus a need of a device or technique that can prolong the time during which the temperature picture can be retained by the measuring device, so that the temperature picture can be registered studied and analyzed, for instance the temperature of one's own or others' feet.

In accordance with the invention the above object is solved in a surprisingly simple way, that we (the inventors) discovered by a coincidence at trials to prolong the durability of a picture with sophisticated steps. It turned out that by an applying of a thicker plastic layer or sheet in front of and or on the back side of a thermochromatic layer one could get the picture to remain a sufficiently long time with maintained sharpness. The solution of the problem was surprising, not only because it quite practically is simple to realize, but also from a principal view since it for the man skilled in the art is considered impossible. That a material that in general is considered as a poor conductor and in many cases insulating would function as a heat accumulator was surprising and that the heat dissipation in the plane of the area was so small was at least equally surprising. Actually questioned makers of thermochromatic materials assured us that it was not possible to prolong the duration of the temperature picture. Two of the inventors have university degrees in the heat area and none of them could imagine this solution.

In this way the available reading time is prolonged, which facilitates study, analyzing and possible registration of temperature conditions at for instance the measuring of foot sole temperatures.

A possible explanation of the invention may be that the plastic layers in front of and behind the measuring layer serve as heat or chill storage for the thermochromatic layers and that the lateral leakage of heat is of little importance, at moderate thickness. Since the heat dissipation in the plane of the area is small stable temperature conditions are supported without increased tendency to equalization over the area. The plastic layers enclosing the thermochromatic layers furthermore prevent these from becoming worn or soiled respectively. With an increasing thickness of the plastic layer (within reasonable limits) the time that the “temperature picture” remain increase. One of the plastic layers is transparent for the reading.

In particular the surrounding plastic layers may be thicker than the thermocromaticly coated plastic or paper layers or plastic layers with enclosed thermochromatic materials respectively. As long as one keeps a thickness that is of the same size as or below the desired resolution in the picture the heat transport towards and out from the thermochromatic layers will reasonably predominate in relation to the lateral heat dissipation towards proximate areas.

In the case with examination of feet a pixel pattern can be used with comparatively large pixels, which further facilitates the obtaining of a comparatively long time stable picture.

Plastics that have turned out to function well on the reading side as well as on the rear side is for instance polycarbonate, polypropylene, polyethene, (LDPE as well as HPDE) and PVC since they are transparent. On the rear side also non-transparent plastics functions such as polyamide and ABS. One can also consider mixtures of plastics as well plastics with additives with heat conduction and heat storing properties that are similar to those of the plastics, that is materials that basically are neither typical heat conductors or insulators.

Since it is the desirable with a small heat dissipation the thermochromatic layers, one or several, are presumably advantageously thin in relation to one or both of the surrounding layers.

A further problem with these devices is however that only a limited number of temperatures can be displayed. This in turn means that, at larger temperature intervals one does not have the possibility to obtain a sufficiently fine separation in different temperature steps for some applications. For instance it can be mentioned that the measuring of the temperature distribution over a skin area, for instance a foot sole or palm of a hand is not possible to solve with the known devices since in addition to a comparatively large temperature interval one needs comparatively small steps between the registered temperatures in order to see if for instance circulation disorders are present.

In view above problem an object of the invention is also to define a device and a method through which a temperature scale with fin steps can be obtained with thermochromatic devices.

In accordance with the invention the above object is solved by over the measured area arranging groups of part areas were the part areas include different mixtures of thermochromatic materials. In this way the different part areas react with change of color at different temperatures and a scale with more measuring points than one mixture can provide is achieved at a reading not only of the color but also of were in the group the color is registered. This registration can for instance take place by comparing each group with a gauge or template.

In a first version the invention can be implemented by placing two layers of thermochromatic material on top of each other. The thermochromatic material is different in the two layers, which by appropriate choice of thermochromatic material reacts at different temperatures so that they together constitute a fine pitched scale over a large temperature interval. By furthermore providing the front or upper of the layers with holes, openings or windows it is possible to register, over the entire area, the local temperature from the combination of colors that is shown at each hole and in the surrounding of this respectively. It is this possible in this way to achieve a larger readable temperature interval given a certain resolution or a higher resolution given a certain temperature interval.

If so desired of course more than two layers may be used and with holes or windows in the above located layers (in the case of three layers in the two upper layers) so that areas from all three layers—or several—can be seen, preferably group-wise.

In accordance with the invention the layers or sheets with thermochromatic properties are enclosed between two plastic layers, one or both of the plastic layers may be provided with a printed pattern that separate the layers into a number of defined detection areas that each include visible groups of part areas for each one of the used layers. In this way the identification of the temperature for each such defined area is facilitated. If so desired the defined detection areas may be numbered in order to facilitate recording.

In another version of the invention one can consider to use a thermochromatic lacquer or ink that is applied in the shape of part areas in each group on a common carrier on the same side of this or one on each side of this.

The evaluation of the temperature conditions may in its most simple version so to say take place by hand by looking at the defined areas one by one and by means of the template noting the temperature in some appropriate way, for instance on a paper with a correspondingly pictured area or on a paper with holes for the part areas, in which latter case the pattern on an upper plastic layer is uncalled for. Within the frame of the invention one may also in a further development of the inventive concept consider to use a scanner to transfer a temperature picture to a computer that can then identify the part areas and register the temperatures of these, then to present the result in an appropriate way, possibly including a providing of quite different colors than the registered ones to the different part areas (and thus temperatures) so that an even more easily understandable picture is obtained.

At the use of the invention to evaluate the temperatures of patients' feet soles it is often sufficient to compare right and left foot. If both show roughly the same temperature distribution the probability for the presence of any circulation disturbances is small and here it is presumably sufficient with a comparatively widely spaced temperature scale, for instance for home use at feet examinations were the important thing is to see if the pictures of right and left foot are symmetrical. If however discrepancies occur one should more closely examine the cause of these, advantageously with a better temperature resolution. The evaluation is in this way essentially facilitated. Perhaps one can even, by suitable complementing making of holes in the layers on right and left foot respectively consider a folding of these so that a superpositioned picture is obtained for right and left foot so that one easily can see if coincidence exist or not point for point.

One can further consider a similar hole structure as in the upper layer being arranged in the lower one so that the temperature conditions and the subdivided reading areas respectively are visible from the bottom side and it is of course also possible to arrange these holes displaced relative each other on the rear side of the device so that one both from the front and from the rear side of the device can get a picture of the temperature conditions. One can also consider the layer on the top side, that you stand on, so to say only provide a rough temperature classification wereas one on the bottom side has a more detailed classification. This can be achieved by arranging two thermochromatic different layers over each other were the indication temperatures of the layers are arranged with the same temperature spacing but a related displacing, corresponding in particular to half of said spacing. Furthermore one arrange holes or windows in the lower layer. In this way one immediately obtain a first rough indication and then check this by turning the device over. As an alternative to the above one can consider an additional layer at the bottom that one can look at from below, which layer may have its own further different composition.

If one only have holes and openings in the top layer and each layer can show every second temperature in the total scale the lower one will at a viewing from the bottom side provide a rough temperature picture. By in a measuring device according to the invention for one foot arrange holes or windows that extend through the device one may by a folding of the measuring device for left and right foot through these openings see the temperatures of each foot at the same time and thereby simply compare the local temperatures of the feet.

By a suitable choice of thermochromatic materials the steps in the temperature scale can be choosen so that this can be made either linear or with the temperature increasing or diminishing steps for instance, or even with more narrow intervals with larger resolution in certain particularly interesting temperature areas.

Further advantages and characteristics of the invention are apparent from the patent claims, as well as from the following description of an embodiment of the invention with reference to enclosed drawing.

In the embodiment of the invention shown in the drawing a plastic sheet 6, which is ½ mm thick, is arranged on top, below this an uppermost thermocromaticly coated paper 1 is placed, provided with numerous round holes 2. Below the hole provided paper a second paper 3 lies coated with thermochromatic material and finally in the bottom there is a further plastic sheet 4, in this case 1 mm thick. Along the edges of the plastic sheets these are joined to each other outside the edges of the papers through fusing, glue or adhesive tape.

The top plastic sheet is on the bottom side provided with a printed pattern 7 dividing the area into a number of hexagons in a honey comb like way concentric with the underlying holes in the upper thermochromatic layer. Within each hexagonal thus a part of the surface of the upper layer as well as also a part of the surface of the lower layer will be visible. The memory effect obtained from the plastic sheets enable reading during essentially longer time than what is possible with only the thermochromatic layers. The colors of the two layers can thereafter be compared with a template from which the color combinations of the different temperatures are apparent. The template may in particular be free and connected to a note paper. In order further to facilitate if so desired, each reading area on the sensing device may be numbered and the note paper provided with a corresponding numbering.

In order to facilitate the measuring it is desirable that the thermochromatic material has a lower temperature (or higher) than for instance a foot that is to be examined, preferably several degrees in order to obtain a clear picture. The measuring device according to the invention may therefor advantagously be chilled (heated) before the measuring. If no refrigerator is available one may instead wipe the device with a spirit or water moistened cloth. The evaporation will then cool the device, that in particular area may be provided with a suitable thermochromatic indicator to indicate if the temperature is low enough or alternatively to high.

The embodiment above can also be made with a thermochromatic printing applied on the bottom side of the upper plastic sheet. At this it does not matter if the upper layer is constituted of dots or a continous area provided with holes. Likewise the different thermochromatic mixtures may be applied only were they are to be seen so that principally one layer is achieved but area-wise comprising different mixtures.

If three layers are used one can consider, as in the shown embodiment, the three areas for each of the layers being placed inside a hexagonal in sectors of 120° each of the same size.

1. Device for temperature registration over an area, characterized in that it includes over an area arranged thermochromatic materials behind of and/or in front of which is applied a comparatively thick layer of plastic or other material with similar heat conducting and heat storing capacity that serve as a heat or chill storage to extend the durability of a registered heat picture.

2. Device according to claim 1, characterized in that the thickness of the surrounding plastic layer or layers is of the same size as the required resolution in the temperature picture.

3. Device according to claim 1, characterized in that in or on the layers with thermochromatic material this is located in groups or areas with different thermochromatic materials or mixtures so that each part area in such a group with its color may indicate different temperatures and that for the part areas in the groups are one or several, or all the indicatable temperatures different, so that a temperature scale can be achieved with more indicatably temperatures than what can be achieved with one and the same mixture.

4. Device according to any of the claim 1, characterized in that the thermochromatic materials or mixtures are arranged in layers and with holes or windows arranged in overlying layers so that part areas of underlaying layers become visible.

5. Device according to claim 1, characterized in that the different thermochromatic layers are arranged on paper, plastic film or sheet and that holes or openings are arranged in the papers, plastic film or sheets so that the thermochromatic layers below or above arranged papers, plastic film or sheets are visible from above and/or below.

6. Device according to claim 1, characterized in that it includes a third layer or more with thermochromaticly deviating mixtures and that two or several of the layers are provided with holes so that part areas of all layers are visible from at least one side.

7. Device according to claim 1, characterized in that a printed pattern is arranged around groups of holes and/or areas so that each part pattern includes shown areas of all layers.

8. Method for the detection and/or registration of the temperature over an area, characterized in that an object, the temperature of which the temperature is to be measured is brought in contact with the measuring area of a device according to claim 1 for a sufficient time to allow the measuring area to take the outer temperature of said object, whereafter said object is removed and immediately read, possibly with a template.

9. Method according to claim 7, characterized in that the device before measuring is chilled in a refrigerator or with a cloth moistened with spirit or water.
